(19) United States
(12) Patent Application Publication
(10) Pub. No.: US 2008/0004977 A1
(43) Pub. Date: Jan. 3, 2008

(54) Digital marketplace to facilitate transactions of creative works

(76) Inventor: Jeffry R. Fisher, Vancouver, WA (US)

Correspondence Address: BRINKS HOFER GILSON & LIONE, P.O. BOX 10395, CHICAGO, IL, 60610, US

(21) Appl. No.: 11/479,030

(22) Filed: Jun. 30, 2006

(51) Int. Cl. G06Q 30/00

(52) U.S. Cl. 705/26

(57) ABSTRACT

A method of auctioning a creative work is disclosed. The method may include initiating an auction for the creative work, where one or more successful bidders receive at least one copy of the creative work, and receiving bids for the creative work from potential buyers. The method may also include closing the auction, determining the successful bidders, generating a limited number of copies of the creative work, the limited number based in part on the determined successful bidders, where each of the limited number of copies is associated with a unique identifier, and awarding each successful bidder at least one of the limited number of copies.

### BACKGROUND OF THE INVENTION

1. Technical Field

The present invention is related generally to e-commerce systems and, more specifically, to marketplaces for distributing creative works and for exchanging rights associated with those works.

2. Background Information

Society has always valued creative works. However, recent technological advancements in replication technology have made it possible for nearly every consumer to massively distribute creative works, especially those conveyed via digital media. For example, peer-to-peer file sharing networks are communication environments that allow all computers in the network to act as servers and share their files with other users on the network. Global peer-to-peer file sharing networks have emerged that allow users to share creative works with nearly anyone on the planet. As a result, wide-scale copyright infringement (aka piracy) of creative works, especially but not exclusively digitally distributed works such as music, movies, and software, has diluted their true market value. For example, a customer may purchase a single audio CD via a traditional distribution channel, upload the content to a computer, and allow any user on the network to download an identical (or nearly identical) copy of the work. Thus, the author of the creative work may be compensated only for very few copies while millions are ultimately distributed for the benefit (and profit) of others.

As a result, owners of these works have employed various techniques to prevent unauthorized copying and to stop the dilution of their works. For example, in the music industry, “digital rights management” (DRM) systems have been developed to ensure that only authorized playback of copyrighted material is allowed. DRM systems enable the owners of creative works to extract more of their work's market value. In such systems, a user typically pays a small fee for downloading a particular work, such as a song, and a predetermined percentage of the fee becomes a royalty for the copyright owner.

Although digital rights management systems are common, many users are dissatisfied by the restrictiveness of such systems. For example, some digital rights management systems may impede certain fair rights uses to which a purchaser of a particular creative work may be entitled. Additionally, many digital rights management systems limit playback to particular devices, such as a computer or digital music player, forcing a purchaser to spend additional money to obtain the proper device. As a result, many potential purchasers may be lost under a digital rights management system.

Furthermore, efforts to enforce copyrights via prosecution have hurt entertainment businesses' public relations generally. Accordingly, a new paradigm for distributing creative works and facilitating the transactions associated therewith is needed.

### SUMMARY

In one embodiment, a method of auctioning a creative work is disclosed. The method may include initiating an auction for the creative work, where one or more successful bidders receive at least one copy of the creative work, and receiving bids for the creative work from potential buyers. The method may also include closing the auction, determining the successful bidders, generating a limited number of copies of the creative work, the limited number based in part on the determined successful bidders, where each of the limited number of copies is associated with a unique identifier, and awarding each successful bidder at least one of the limited number of copies.

In another embodiment, a system for distributing intellectual property works is described. The system may include a creative work definition component, the creative work definition component operable to input an identifying description of a creative work into the system. The system may also include a creative work offering component, in communication with the creative work definition component, operable to offer, via a cooperative auction, a creative work associated with a seller, the seller able to set a minimum for net proceeds payable thereto. The system may also include a creative work wanted component, in communication with the creative work definition component, operable to solicit, via an auction, a creative work not yet associated with a willing seller, so that speculative buyers may attempt to accumulate a potential yield to attract a creative work's owner or owners to sell or make a counter-offer. The system may also include a bid reception component in communication with the creative work offering component and operable to receive bids for the creative work from potential buyers, where each bid may include a maximum value and possibly other parameters such as a minimum value. The system may also include a bid tabulation component in communication with the bid reception component and operable to calculate a gross profit value for a plurality of potential unit prices, the bid tabulation component further operable to select a final unit price for the creative work based on the calculated gross yield values; and a wining bid selection component in communication with the bid reception and bid tabulation components, the wining bid selection component operable to select those bids having a maximum value equal to or greater than the final unit price. The system may further include a fund verification and collection component in communication with the bid tabulation component, the fund verification and collection component operable to secure funds from the buyers for the selected bids; and a work generation component in communication with the fund verification and collection component, the work generation component operable to cause a copy of the creative work to be generated for each bid for which funds are secured, where the works are serially numbered.

In yet another embodiment, a method of auctioning a creative work is disclosed. The method may include initiating an auction for the creative work, determining a final unit price for the creative work, where at least one bid includes a premium indicative of an amount above the final unit price, and selecting a subset of winning bids from the received bids in accordance with the final unit price. The method may also include generating at least one copy of the creative work for each winning bid, and awarding the copies to the buyers placing the winning bids in accordance with the premium.

In still another embodiment, a method of auctioning a creative work is disclosed. The method may include receiving a request for initiating of an auction for the creative work from a potential buyer, initiating the auction, and receiving bids for the creative work from potential buyers. The method may also include receiving, after receiving at least one bid, finalized auction terms from an owner of the work, closing the auction; and determining the successful bidders.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for facilitating a transfer of a creative work;

FIG. 2 is a flow chart of exemplary steps in a typical transaction for a creative work;

FIG. 3 is a diagram of exemplary functional aspects of a creative work transaction server;

FIG. 4 is a diagram of exemplary milestones or phases of an auction for a creative work;

FIG. 5 is a diagram of exemplary functional elements of a web site configured to facilitate a transaction for a creative work;

FIGS. 6A and 6B, together FIG. 6, show an exemplary screen shot of a web page for product description and bid submission page of the web site of FIG. 5;

FIGS. 7A and 7B, together FIG. 7, show an exemplary screen shot of a web page, in the web site of FIG. 5, for defining a creative work after having navigated through product type and subcategory selection pages not shown; and

FIG. 8 is an exemplary screen shot of a web page, in the web site of FIG. 5, for setting auction parameters after defining a product in FIG. 7.

### DETAILED DESCRIPTION OF THE PREFERRED EMBODIMENTS

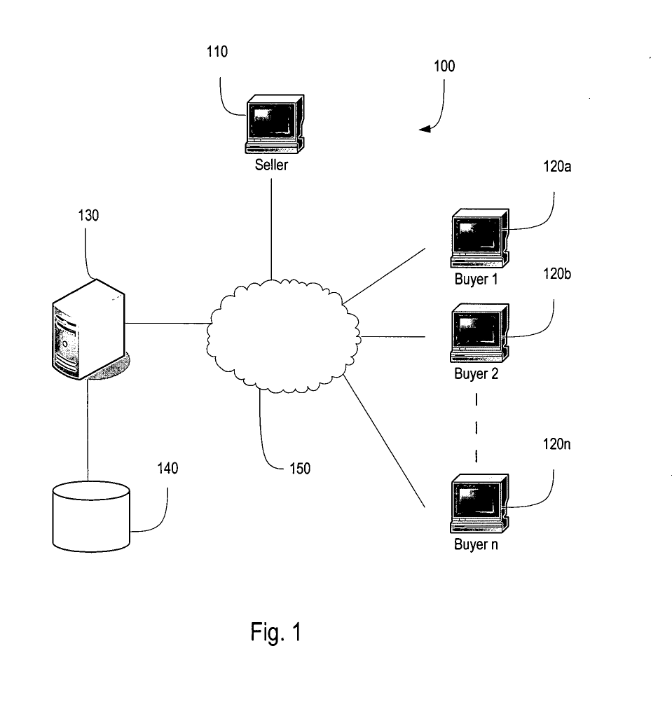

Referring now to the drawings, and specifically to FIG. 1, an exemplary system 100 for facilitating a media transfer is shown. The system 100 may include a seller client system 110, one or more buyer client systems 120a, 120b, and 120n, a creative work transaction server 130, and a database 140. Although reference will now be made to specific components of the system performing specific features, it should be apparent to one of ordinary skill in the art that such reference is exemplary, is not intended to limit the scope of the claims in any way, and that the functionalities described herein may be implemented in a virtually unlimited number of configurations. For example, although figuratively attached to transaction server 130, database 140 may, in practice, distribute user-specific data elements (such as user preferences) to client systems 110 and 120. Also, the creative work transaction server 130 may be implemented as a single server configured to provide all of the system's functionalities, or the functionalities may be implemented across multiple servers. Similarly, the seller client system 110 and buyer client systems 120a, 120b, and 120n may be implemented as a single client system configured to provide both buyer and seller related functionalities.

The system 100 may facilitate the exchange of creative works as the result of a product being created and offered for sale by a seller and that product being awarded to one or more successful bidders or buyers. Product creation entails the steps required to create a product offering and may include such processes as defining a seller's identity, defining product detail information, and defining a reserve price for the product. As used herein, the terms “creative work” and “product” include any work that may be prone to propagation and/or amenable to copy protection. Such works may include literary works, musical works, dramatic works, pantomimes and choreographic works, pictorial, graphic, and sculptural works, motion pictures and other audiovisual works, sound recordings, cultivars, scientific data, trade secrets, pharmaceutical formulae, and the like. The systems and methods disclosed herein are not limited in the types of creative works that may be used.

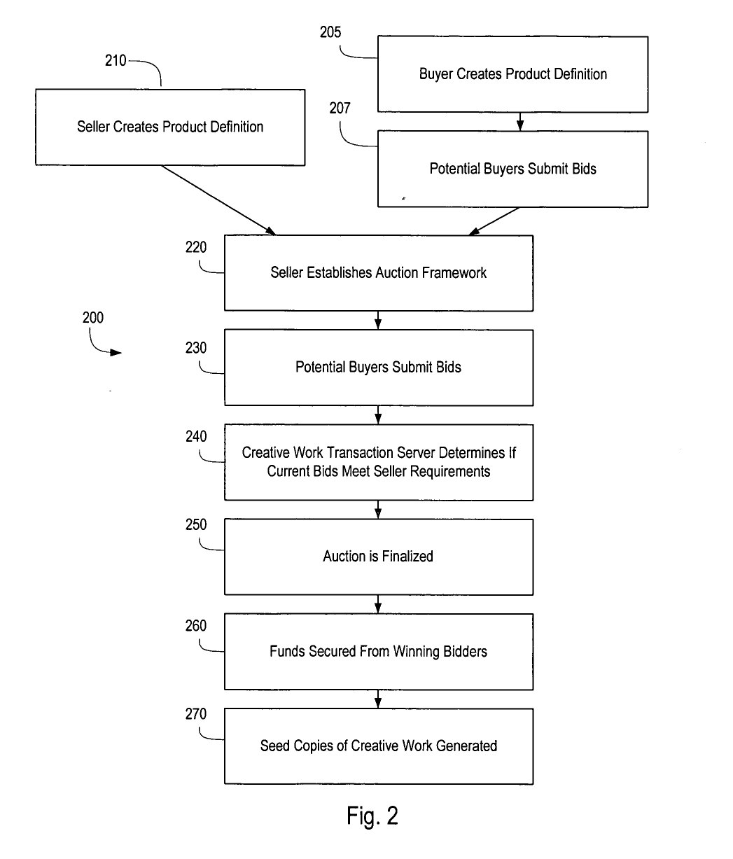

Exemplary steps 200 in a typical transaction are shown in FIG. 2. In order to create a product offering, a seller may utilize the seller client system 110 to connect to the creative work transaction server 130 via a communication network 150. The communication network 150 may be any private or public communication network. Preferably, the seller client system 110 may connect to the creative work transaction server 130 via the Internet using a standard browser application. A browser based implementation allows system features to be accessible regardless of the underlying platform of the seller client system 110. For example, the seller client system 110 may be a workstation computer, laptop computer, handheld computer, mobile phone, or the like which may all utilize different hardware and/or software packages. The creative work transaction server 130 may be a web server that delivers Web pages to browsers (and other files to applications) via the HTTP protocol. Alternatively, or additionally, the seller client system 110 may connect to the creative work transaction server 130 using a stand-alone application which may be either platform dependent or platform independent. One of ordinary skill in the art will appreciate that other methods may be used to implement the seller client system 110.

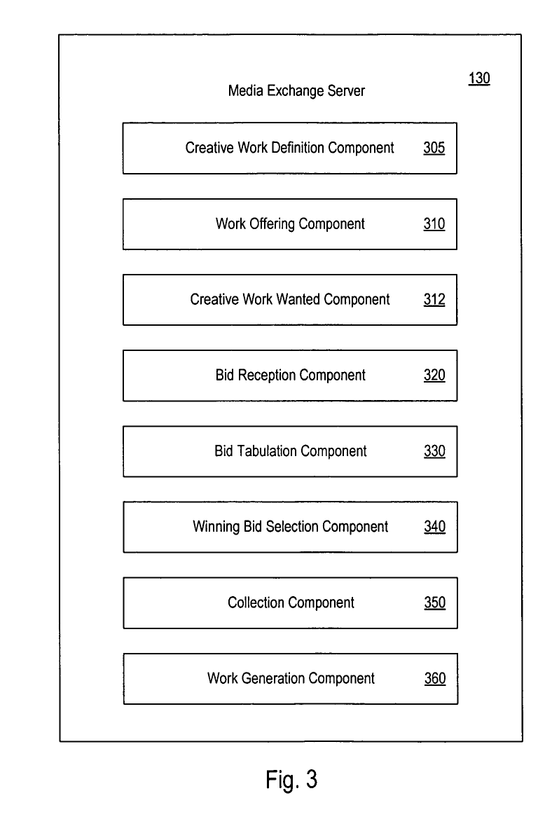

Once connected, the seller client system 110 may provide access to a variety of features provided by the creative work transaction server 130. The creative work transaction server 130 may provide services that allow a seller to log in and/or register for the system 100, create a product offering, manage a transaction of the product, facilitate the manufacturing of a product, facilitate the delivery of a product to one or more successful bidders or buyers, and the like. A diagram showing exemplary functional aspects of the creative work transaction server 130 is shown in FIG. 3. The creative work transaction server 130 may include a creative work definition component 305, a work offering component 310 for offering a creative work, a creative work wanted component 312 for establishing buyer initiated auctions, a bid reception component 320 for receiving bids for the creative work, a bid tabulation component 330 operable to calculate various information from the received bids, a winning bid selection component 340 for determining the winning bids from the received bids, a fund verification and collection component 350 operable to secure appropriate funds for each winning bid, and a work generation component 360 operable to cause copies of the creative works to be generated for each winning bid and/or cause the generated works to be distributed to the successful bidders. It should be apparent to one of ordinary skill in the art that these labels are illustrative and are not intended to limit the creative work transaction server 130 to a particular hardware or software configuration. For example, each component 305-360 of the creative work transaction server 130 may be implemented as an individual software or hardware component, or any combination of the two, and multiple components 305-360 may be implemented together in an integrated program or device. Moreover, additional components also may be included as part of or in combination with the creative work transaction server 130.

Users, such as buyers and/or sellers, may be required to log in to the system 100 in order to access system features. User information, such as a user name, password, demographic information, and the like, may be exclusive to the creative works exchange system 100 or may be leveraged with other systems. For example, the system 100 may be provided as part of a general purpose Internet portal. Alternatively, or additionally, the system 100 may leverage login information from multiple existing systems. Optionally, the system 100 may require users to complete an additional stage of registration and agreement before they may act as sellers. Alternatively, no login information may be required to access the system 100.

To initiate a transaction, a seller may select a product type, a category and a subcategory defined by the creative work transaction server 130, and then define a product at 210. Product offerings may be created via the creative work offering component 310, or in any other way. A product offering may include defining a product and establishing the auction framework for the transaction. When defining a product, a seller may specify certain information about the creative work as applicable. For example, the seller may specify product type; product category, subcategory and cross category; title, subtitle and version; a seller identifier; creator; indication of this being the work's first publication; ratings by various criteria such as suitability for various audiences; national origin; written and/or spoken language(s) therein or on packaging; number of disks per package; packaging type; general description; and the like. Optionally, the seller may update certain information about the product and/or parameters of the auction while the auction is in progress. Optionally, the system 100 may limit the items or ways that items may be edited depending on criteria such as auction phase. The specified information may be stored in the database 140 by the creative work transaction server 130. System 100 generated information about the product may also be stored in the database 140. The system 100 may generate information such as a product identifier, which may be a monotonically increasing integer; a timestamp; or any of the specified information noted above. Other system 100 generated information may also be used. The system 100 is not limited in the types of information that may be maintained about a particular work.

Next, the seller may establish the framework for a transaction or auction at 220. In creating an offer, a seller may specify information about the proposed transaction. For example, a seller may specify a target date for completion of the transaction; a net proceeds demand; and how many packages to buy if a manufacturing overrun emerges. In addition, the seller may agree to pay a listing fee that might be calculated from the seller's net proceeds demand. The creative work transaction server 130 may then calculate derived data such as implied brokerage fee; total target yield; and per unit manufacturing, packaging, and shipping costs. Optionally, the creative work offering component 310 may allow the seller to associate (bundle) a newly described product or products with another of the seller's products already in the system, the new product's proceeds adding toward the target yield and depending on the target date of the first product in the bundle. For example, assume that a studio wants to simultaneously sell full-screen, letter-box and deluxe DVD versions of a movie, but does not want to guess how much net revenue to demand of each auction separately. So, the studio may first offer one version and specify a net proceeds demand corresponding to their combined DVD revenue expectation for the movie, and then bundle the second version with the first, and finally bundle the third version also with the first. The bid tabulation component 330 of system 100 may then process the auctions separately, determining each auction's best unit price and winning bidders independently. The combined yields of all three auctions would then serve to satisfy the shared revenue target, and the one shared target date would synchronize auction completion. The specified information may be stored in the database 140 by the creative work transaction server 130. System 100 generated information about the transaction may also be stored in the database 140. The system 100 may generate information such as a total number of bids; a calculated best price; a calculated yield; an authentication indicator; a gross collected amount; total manufacturing, packaging, and shipping costs; amount (to be) paid to seller; a deliverable date; an indicator that the target yield has been met; a closing date; a last saved date; and an auction phase. Other seller specified and system 100 generated information may also be stored in the database 140.

The seller may also indicate at least one right associated with the creative work. For example, the seller may indicate a right to reproduce the work, to prepare derivative works based upon the work, to distribute copies of the work to the public by sale or other transfer of ownership, or by rental, lease, or lending, to perform the work publicly, or in the case of certain works, to display the work publicly. The indicated right or rights may be released into the public domain when the auction successfully closes. Alternatively, a predetermined set of rights associated with a creative work may be released to the public domain upon completion of an auction, obviating the need for a seller to choose particular rights. The predetermined set of rights may include a single right associated with the work, such as a right to reproduce the work, all rights associated with the work, or any combination of rights associated with the work.

Once a product offering has been created, buyers may submit bids for the product at 230. Bids may be submitted via the bid reception component 320, or in any other way. Buyers may connect to the creative work transaction server 130 over the communication network 150 via the buyer client systems 120a, 120b, and 120n. Preferably, the buyer client systems 120a, 120b, and 120n may connect to the creative work transaction server 130 via the Internet using a standard browser application. The buyer client systems 120a, 120b, and 120n may be a workstation computer, laptop computer, handheld computer, mobile phone, or the like which may all utilize different hardware and/or software packages. Alternatively, or additionally, the buyer client systems 120a, 120b, and 120n may connect to the creative work transaction server 130 using a stand-alone application which may be either platform dependent or platform independent. One of ordinary skill in the art will appreciate that other methods may be used to implement the buyer client systems 120a, 120b, and 120n.

When submitting a bid, a buyer may specify certain information about the bid. For example, the buyer may specify a minimum bid amount, a maximum bid amount, buyer information, and payment method information. This information may be stored in the database 140 by the creative work transaction server 130. System 100 generated information about the bid may also be stored in the database 140, and may include product and/or transaction identifiers, timestamps denoting creation and/or effective dates, a bid identifier, and bid status information. Other system 100 generated information may also be used. The system 100 is not limited in the types of information that may be maintained about a particular bid.

As an alternative to seller initiation, a potential buyer may define a known or anticipated creative work and spawn an auction, without a seller's auction parameters, in the hope that the potential proceeds implied by unsolicited bid reception will attract the work's owner to join the process and complete the auction framework. A buyer initiated auction may be created using the creative work wanted component 312, or in any other way. In this situation, the auction processes are similar to those described for a seller-initiated offer. However, the minimum proceeds and possibly other terms of sale would still need to be set (or the implied proceeds accepted) by the owner of the work; therefore, a buyer-initiated auction may not close successfully until after the owner of the work responds with an acceptance or a counteroffer. As shown in FIG. 2, an exemplary buyer-initiated auction may begin with a potential buyer choosing to create a definition for a known or potential product at 205. That buyer and/or additional buyers may bid on the item at 207 (which may have the same process as at 230), which may attract the interest of the owner of the work to sell the work. The owner may then finalize the terms of the auction at 220, and the auction may continue as described herein for seller-initiated auctions.

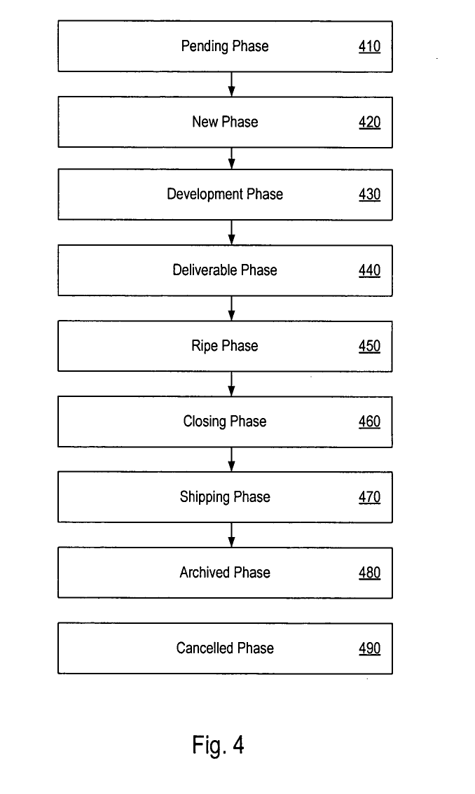

Once a product offering is created, the auction may progress through a series of phases. Exemplary phases for an auction for a creative work are shown in FIG. 4. For example, an auction may have a pending phase 410 when only the seller and system administrators can see it; a new phase 420 when statistics are not useful and therefore not displayed; a development phase 430 when the creative work has not yet been proofed and authenticated; a deliverable phase 440 when the creative work is ready for replication and/or distribution but auction targets have not been met; a ripe phase 450 when targets appear to have been met but money has not yet been collected; a closing phase 460 when buyers and would-be buyers are notified of the closing price; a shipping phase 470 when disks or other media may be manufactured and shipped (or when data may be transmitted), customer complaints may be received, and successful buyers may, at their option, be publicized on the creative work transaction server 130; an archived phase 480 when customer complaints may be rejected; and a canceled phase 490 if an auction is stopped, is rejected, or has otherwise failed for any reason.

The pending phase 410 may correspond to the phase in which the auction is awaiting approval from the system. During the pending phase 410, a listing fee may be demanded and/or information about the auction may be censored by the system 100. For instance, the description text may be scanned for conformance to terms of use. The new phase 420 may correspond to the phase in which an auction has gained approval from the system 100, but has yet to receive any bids, or alternatively, a significant number of bids or significant yield from the received bids. The development phase 430 may correspond to the phase in which the creative work being auctioned may be under development and incomplete, or its sale may not proceed for any reason, such as competing, divided, or unproven copyright claims. The deliverable phase 440 may correspond to the phase in which the creative work is complete and the seller authenticated, but the auction has not met either or both of its associated targets for completion date and yield. The ripe phase 450 may correspond to the phase in which the completion date and target yield have been reached, and funds are being verified by the system 100. The closing phase 460 may correspond to the phase in which the necessary funds have been secured for a successful sale. The shipping phase 470 may correspond to the phase in which copies of the creative work are generated and distributed to the successful bidders. The shipping phase 470 may be extended for a predetermined time period to allow for customer complaints. The archived phase 480 may correspond to the phase during which information about a closed auction may be stored or relocated by the system 100. For example, the system 100 may liberate resources by deleting obsolete portions of auction data or archiving off-line, or some combination. Finally, the cancelled phase 490 may correspond to the phase in which an auction has been withdrawn by the seller and may be ignored by the system 100. An auction may enter the cancelled phase 490 from any other auction phase. One of ordinary skill in the art should appreciate that these phases are merely exemplary, and that implementations having less, different, or additional phases do not depart from the functionalities described herein.

The creative work transaction server 130 may determine if the current bids meet the target yield at 240. This may be determined using the bid tabulation component 330, or in any other way known in the art. Current yields may be calculated after a single bid is received, or after a predetermined number of bids are received. Additional milestones for calculating a current yield may also be used. For example, calculations may be performed for any auction in the deliverable phase 440.

Because auction yield is not an obvious or monotonically increasing function of price in multi-unit auctions, the creative work transaction server 130 may determine a current best price that corresponds to the largest gross profit available based on the current bids. Accordingly, both the number of winning bids and the value of the winning bid may be variable. For example, if bid maxima of $10, $15, and $100 were placed on an item, the system 100 may determine a best unit price of $100 for a single copy of the creative work. As another example, if bid maxima of $35, $50, $60, and $100 had been submitted, the system may determine a best unit price of $50 for each of three copies of the creative work. Optionally, the creative work transaction server 130 may discount each bid for estimated manufacturing, packaging, and/or distribution costs in determining the best price. In addition, if bid minima are processed, then when a price is tested below a bid's minimum, the system may count that bid for its minimum rather than the lesser test price when calculating that price's potential yield. The system may allow the seller to specify a minimum or maximum number of units to be distributed for a given transaction, and the system 100 may determine a best price based on this constraint. The system 100 might calculate a best price only for auctions having at least some particular number of bids, and may calculate a best price on a periodic basis, such as every day, once a week, every day during the last week of a transaction, and the like. Other methods and factors may also be used to determine a best price.

After a best price has been determined that meets or exceeds the target yield, the auction may be finalized at 250. Optionally, the auction may continue to run until the target end date. Auction finalization may correspond to the ripe phase 450. The winning bid selection component 340 may be utilized to finalize the auction. In finalizing an auction, the system 100 may set the calculated best price as the final price and determine the successful bidders. Successful bidders may be those bidders whose maximum bid value meets or exceeds the final price. Successful bidders may also be determined using other criteria.

Once a final price has been determined, the system may optionally allow additional buyers (referred to herein as “last minute buyers”) to purchase the item at that price. This may allow losing bidders a second opportunity to purchase a creative work, and may further increase the yield of a particular auction. For example, last minute buyers may be able to submit purchase requests for the creative work at the final price during the closing phase 460 of an auction. The closing phase 460 may last for a predetermined time after the final price is determined. Alternatively, or additionally, the closing phase may last until a predetermined time after receiving a request from a last minute buyer to allow for hot items to remain available for a longer time period.

During the ripe and closing phases, funds may be held upon and/or captured from the successful bidders at 260. Funds may also be secured from last minute buyers. The funds may be secured by the collection component 350 of the creative work transaction server 130. The collection component 350 may be implemented as a typical transaction server for facilitating a transaction between the seller and one or more buyers, as known in the art, and may involve communication with and/or various degrees of integration with one or more external systems providing services (e.g. merchant accounts and/or payment “gateways”). Funds may be secured from accounts associated with the system 100. For example, each bidder may be required to establish an account with the system 100 for holding funds associated with a particular bid or multiple bids, and the funds therein may have been remitted by any practical means (e.g. cash, check or money order), and system 100 may have issued a remittance schedule or reminders that it may have determined from criteria such as auction phase. Alternatively, or additionally, funds for a particular bid may be secured from an account maintained outside of the system 100, such as an account maintained by a financial institution. Such accounts may include, for example, a checking or credit card account maintained by a bank. Such accounts may be accessed directly through the account issuer itself, or indirectly through a payment gateway or internet commerce service (e.g. Paypal).

Finally, seed copies or versions of the creative work may be created for each successful bidder at 270. As used herein, the terms “seed copy”, “seed version”, “original” and “master” are used to refer to any copy of the work generated in response to a successful bid. Seed copies may be generated by the work generation component 360 of the creative work transaction server 130. Alternatively, or additionally, external resources (which may include separately negotiated manufacturing and/or delivery capacity of the seller) may be employed to generate the seed copies, either independently or in conjunction with the work generation component 360. For example, a seed copy of a sound recording may be generated as a CD, DVD, audio tape, or the like. One creative work's seed copies may be generated on assorted media. The seed copies may then be awarded to the successful bidders (buyers), such as causing the seed copies to be distributed to the buyers. Again, external resources may be used to award the seed copies to the buyers, for example, by contacting a third party to distribute the seed copies. Once seed copies are awarded to the buyers, each buyer may exercise whatever rights in the work have been included in the auction or released to the public domain. For example, buyers may be free to disseminate the work in whole or in part. If rights have been released to the public domain, then the buyers' customers will also be free to exercise those rights, ad infinitum.

Seed copies may be designated with a unique identifier or distribution number. The identifier may be a monotonically increasing integer such that the seed versions are ordinally ranked. For example, three seed copies of a creative work, numbered 1, 2, and 3, respectively, may be generated for an auction having three successful bidders. The unique identifier may also be a radio frequency identification tag (RFID), a wireless data collection technology that uses electronic tags for storing data that is used to identify items. Other identifiers may also be used. When placing a bid, bidders may indicate a willingness to pay a premium above the determined final price. This premium may be determined by a minimum bid value associated with each bid that corresponds to the minimum amount a potential buyer offers to pay for the work and a superior ranking, or the premium may be determined in any other way. In such a scenario, if the final price is lower than a minimum bid value, the difference in price may constitute a premium. Seed copies may be distributed to the bidders in accordance with the indicated premium, such that a seed copy with a lower (superior) distribution number may be distributed to a bidder paying a higher premium. Alternatively, seed copies with lower distribution numbers may be awarded to bidders with the highest maximum bid, or may be awarded to bidders in any other manner, such as earliest bid reception date. Buyers may receive other consideration according to rank (e.g. advantageous listing on product detail page 526 of the web server 500 after an auction closes). By ranking winning bids in this manner, the system 100 essentially creates an auction within an auction, or secondary auction, as the successful bidders may compete with one another for the most desirable copies of the work. As a result, the system 100 may generate additional revenue for the seller.

Optionally, a seed version of the creative work may be reserved for the seller and/or broker who operates the system. The seller and/or broker may receive the lowest numbered or any other arbitrarily determined master(s). In addition, a manufacturing overrun may be divided and accounted for according to data previously collected in step 220 and/or calculated therefrom by the creative work offering component 310 and stored in the database 140. Each seed copy may also include accompanying tangible and intangible bonus material and benefits, such as, but not limited to: artistic packaging, instructions, certificates of authenticity, customer support promises (e.g. for software) and the like. In addition, the system may publicly display any or all winning bidders' names, their rankings, and certain associated data. Optionally, the system may allow users viewing the data to search for an auction's winning buyers by zip code or other characteristic. Alternatively, the system might show only the highest ranked winners, or any combination of winner subsets. In such displays, the system might filter out certain winners or certain of their associated data according to one or more preference parameters maintained by those users in system 100 and stored in database 140. Bonus material and/or benefits may be packaged with the seed copy or delivered separately, and such may be of value only to the possessor or, in some instances, only to the original buyer of record. Other materials may also be included with the seed copies.

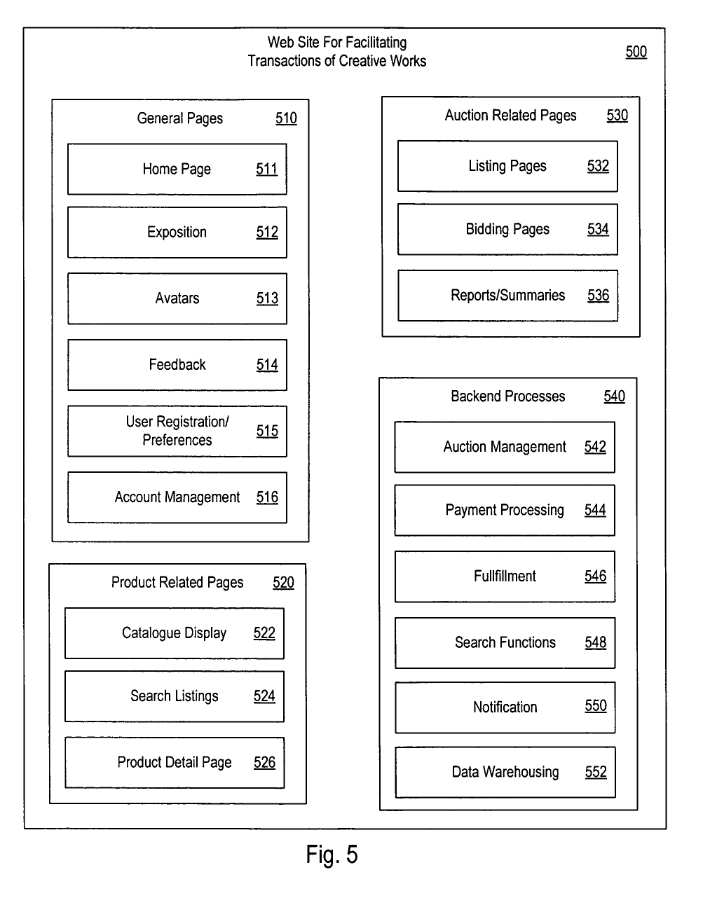

FIG. 5 is a diagram of exemplary functional elements of a web site 500 configured to facilitate a transaction for a creative work. As illustrated, the web site 500 may include general pages 510, product or creative work related pages 520, transaction or auction related pages 530, and back-end processes 540 to facilitate an auction for a creative work. The general pages 510 may include a home page 511, exposition pages 512, avatars 513, user registration and/or preferences pages 514, account management pages 515, and feedback pages 516. The home page 511 may act as a portal to the site and may provide links to the other pages and sections of the web site 500. The exposition pages 512 may provide information about the site, such as legal disclaimers, instructions on performing certain functions like creating an auction and placing a bid, and the like. The avatars 513 may be virtual people (anthropomorphic decorations) that appear on any page to inform and/or comfort users. Avatars may represent experts on particular topics and provide additional information that may or may not be duplicated in the exposition pages 512. For example, a lawyer avatar 513 may be displayed adjacent to a form or action button to alert a user to an obligation implied by completing the form or action.

The feedback pages 514 may allow a user to send feedback to the site 500. The user registration/preferences pages 515 may allow a user to register with the web site 500. As described above, a user may be required to register with the system before creating an auction or placing a bid. To register, a user may be required to provide certain information. For example, a user may be required to enter a user name, password, security question, answer to the security question, a first name, a last name, one or more email addresses, home or shipping addresses, phone numbers, and the like. Optionally, a user may declare itself as a fictitious business entity and provide additional information. Optionally, a user may also have the opportunity to set certain preference information. Exemplary preference information may include a preferred language, product subcategories to watch, notification filters, and the like. The user registration/preferences pages 515 may also allow a user to change this information as desired.

The account management pages 516 may allow a user to establish a financial account with the transaction server 130. For example, the user may be allowed to establish an account, to add or remove money therefrom, and the like. Alternatively, or additionally, the account management pages 515 may allow users to link financial accounts maintained at financial institutions with their accounts.

The web site 500 may also include product related pages 520. The product related pages 520 may include catalog display pages 522, search listing pages 524, and product detail pages 526. The catalog display pages 522 may allow a user to search for works of a particular sort. The catalog might be organized hierarchically. For example, a particular work may be listed within a “Punk” subset of “Rock” subset of “Music” subset of “Audio”. The catalog and its search function(s) may also be arranged using virtually any product characteristic or combination of characteristics, such as title, country of origin, creator (author), rating, version, target date, and the like. A creative work may be listed under more than one category. The organization of the database 140 need not correspond to the organization of any particular input form, display or search function.

A user may also search for a specific creative work using the search listing pages 524. The search listing pages 524 may allow the user to perform a search of the products, such as a keyword search. The search pages 524 may allow the user to search works based on non-hierarchical information, such a title, subtitle, description and the like. The search pages 524 may also allow a user to search products based on hierarchical information, or a combination of hierarchical and non-hierarchical information. The search listing pages 524 may trigger the back-end search processes 548 to perform the search and later notify the user of results, even including new products submitted subsequent to the initiation of the search.

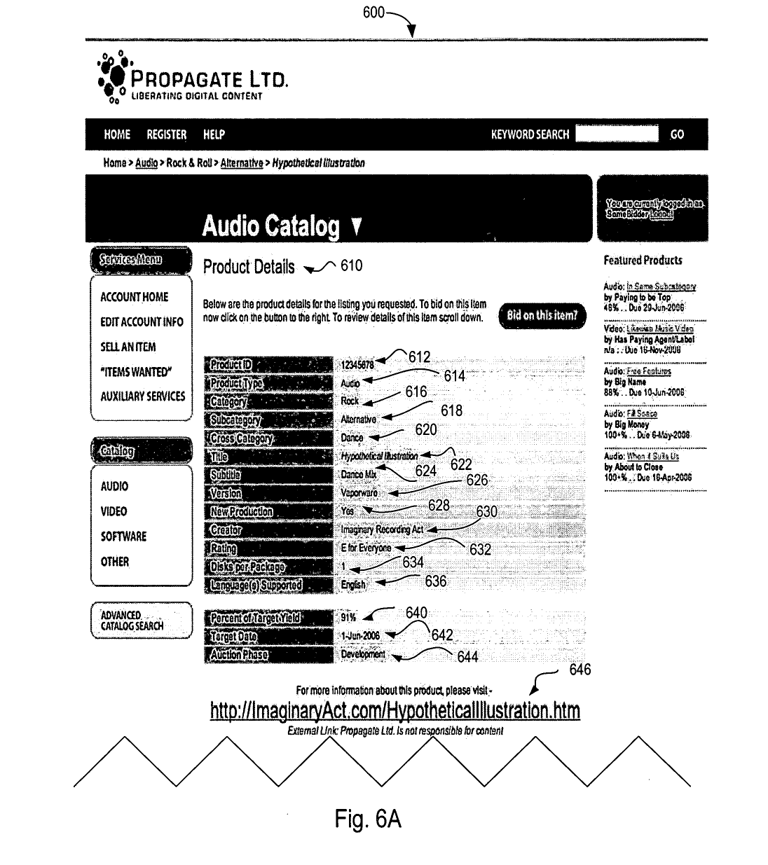

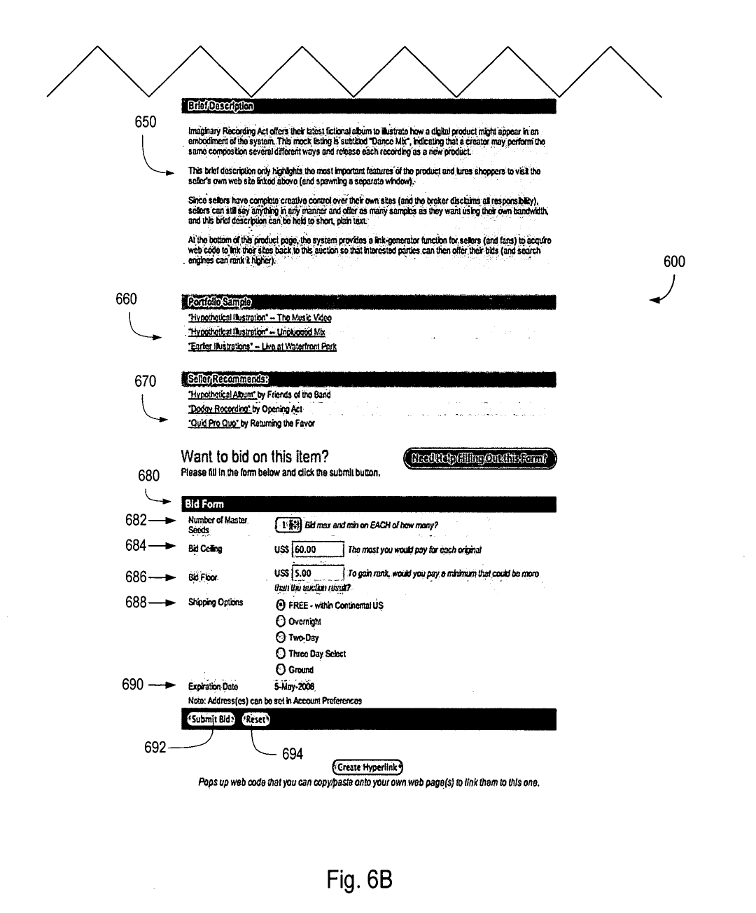

The product detail pages 526 may allow a user to view information specific to a creative work and its auction. An exemplary screen shot 600 of a web page for viewing a product or creative work for the web site 500 is shown in FIG. 6 (which includes FIGS. 6A and 6B). As shown, the page 600 may show product details 610 for a given creative work. The product details may include a product ID 612 (which may be system generated), a product type 614, a category 616, a subcategory 618, a cross category 620, a title 622, a subtitle 624, a version 626, a new production indicator 628, a creator 630, one or more ratings 632, a number of units per package 634, and information about the languages supported by the work 636. The product details page 600 may also include information showing the percentage of the target yield obtained based on the current bids 640, a target date for the auction 642, and an auction phase 644. By showing information such as the percentage of target yield 640, target date 642 and auction phase 644, the system 100 may entice interested buyers to submit bids as auctions near completion. Additional product related information may also be included in the product details page, such as a link 646 to an additional page associated with the product, a brief description of the product 650, a portfolio sample of the seller's or creator's other listed works 660, and any other listed products recommended by the seller 670.

The product detail page 600 may also include a bid submission form 680. Alternatively, or additionally, the bid submission form 680 may be provided independently of the product detail page 600. To submit a bid, the potential buyer may specify a number of seed versions desired 682, a bid ceiling (maximum) 684, a bid floor (minimum) 686, shipping options 688, and an expiration date 690. Other information may also be included in the bid form. The bid form 680 may also include controls for submitting the bid 692 or resetting the information in the form 694.

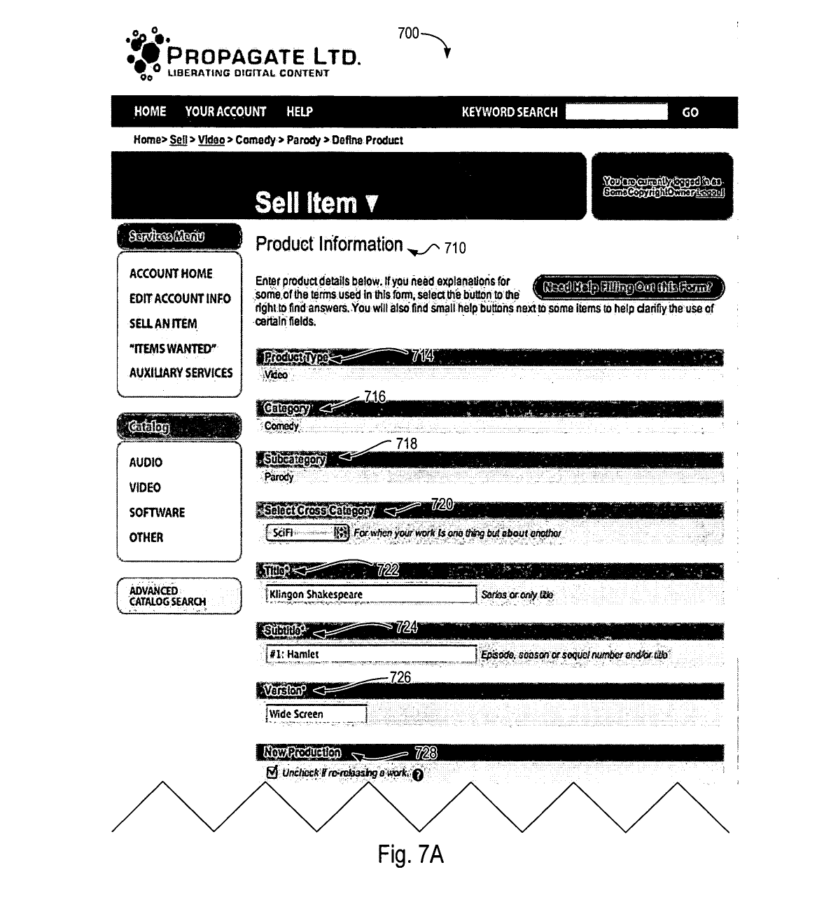

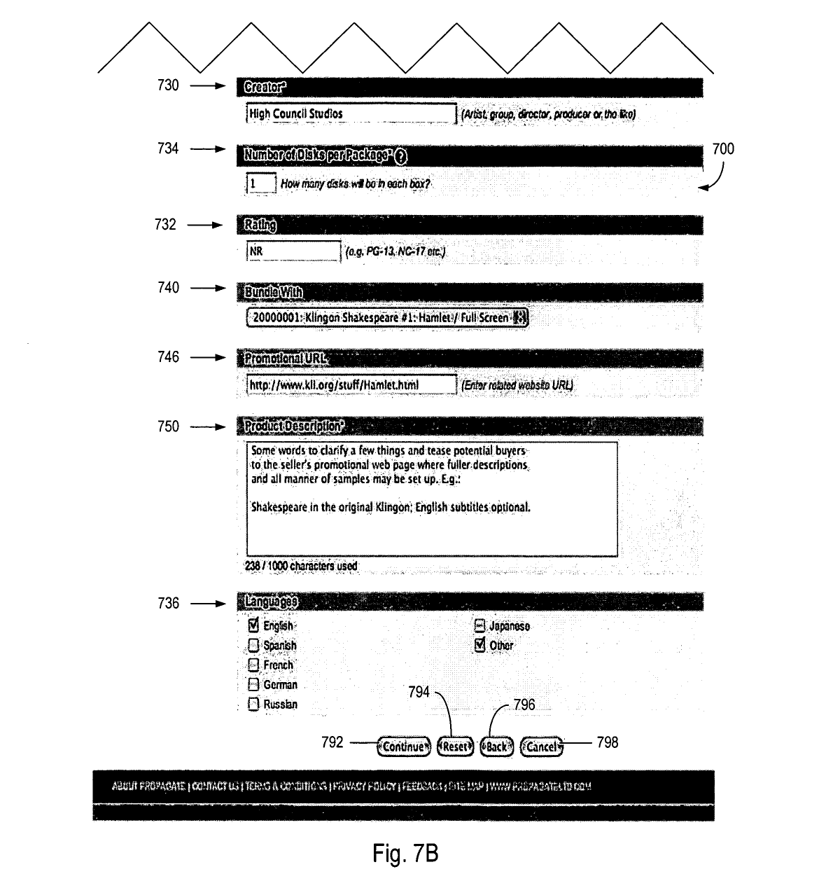

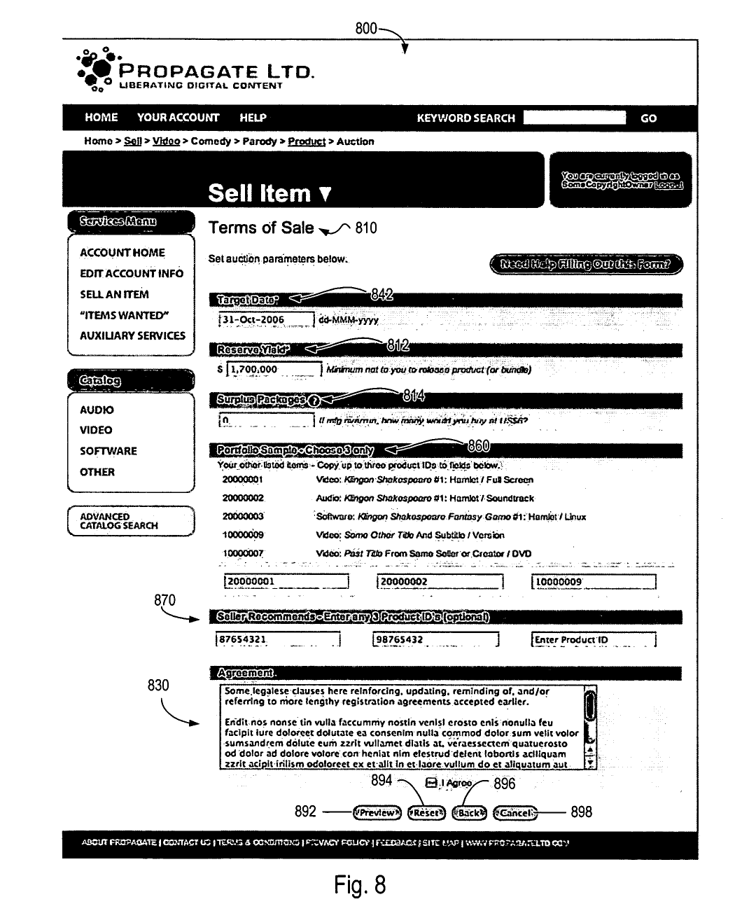

The website may also include auction related pages 530. The auction related pages may include listing pages 532, bidding pages 534, and reports/summary pages 538. The listing pages 532 may include pages that allow a seller to create an auction. An exemplary screen shot of a web page for creating a product listing and auction for the web site 500 are shown in FIGS. 7 (which includes FIGS. 7A and 7B) and 8. As shown, the product listing page 700 may allow the seller to specify product details 710 for a given creative work. The product details may include a product type 714, a category 716, a subcategory 718, a cross category 720, a title 722, a subtitle 724, a version 726, a new production indicator 728, a creator 730, a rating 732, a number of units per package 734, information about the language(s) supported by the work 736, another of seller's products with which the current work may bundle 740, a promotional URL 746, and a product description 750. The product listing page 700 may also include controls for submitting the product information 792, resetting the information in the form 794, returning to previous pages 796, or canceling the creation of the listing 798.

After specifying the product details, the seller may specify the terms of the auction 810 via the auction creation page 800 shown in FIG. 8. For example, the seller may specify a target date for the auction 842, a reserve yield 812, the number of surplus copies of the work the seller is willing to absorb 814, additional works from the seller's portfolio to be displayed with in the current auction 860, and additional listed products the seller may recommend 870. The auction creation page 800 may also include (or remind seller of) the terms of the auction 830 to which the seller must agree in order to make use of the system 100. Additional information may also be included in the auction creation page 800. The auction creation page 800 may also include controls for finalizing the auction 892, resetting the information in the form 894, returning to previous pages 896, or canceling the creation of the auction 898.

The bidding pages 534 may include pages that allow a buyer to create a bid for a creative work. As described above, the bidding pages 534 may be incorporated into the product detail page 526. Alternatively, or additionally, the bidding pages 534 may be implemented independently. Report/Summary pages 538 may also be provided by the web site 500. The report/summary pages 538 may allow a buyer or seller to examine various statistics about one or more auctions or user's other activity in the system.

The web site 500 may also include several back-end processes 540 for facilitating a transaction for a creative work. Back-end processes may communicate with and support each other. These back-end processes 540 may include, auction management processes 542, payment processing processes 544, fulfillment processes 546, search functions 548, notification processes 550, and data warehousing processes 552. The auction management processes 542 may include functions for ranking open auctions to be featured in promotional slots, expiring old bids, calculating auction specific information, such as detecting if targets or phase thresholds have been achieved, and any other functionality described above. For example, Table 1.0 shows an exemplary auction management process 542 to determine, among other things, optimum unit prices maximizing gross profits for open auctions.

TABLE 1.0
Exemplary Yield Calculation Subroutine (in C++)

| | |
|---|---|
| // | |
| // Name & | Version |
| // | |
| // YieldCalc.cpp | v 1.0.0 |

//
// Parameters:
//
// Argv [1] => DB host string
//
// Purpose:
//
// calculate the apparent yield of each open auction
// Set bid statuses
// Detect auction/bundle sufficiency
// Save calculated values
// Send various notifications
//
// Usage:
//
// Run periodically (e.g. daily) by system CRON script
// If run more often than daily, then the notifications will need stutter filters
//
// Design Notes:
//
// Main program...
//
// Process each current auction...
// calculate and store yield curve
// Detect and store maximum yield and its corresponding price
// Detect and report yield-induced phase changes
//
// with a little shuffling, we could wrap this in a wake/sleep loop to
// handle its periodicity

| | |
|---|---|
| #include <stdio.h> | // printf, stderr |
| #include <stdlib.h> | |
| #include <string.h> | |
| #include “Propagate.h” | // P_{—} project-global typedefs and defines |
| #include “DB.h” | // DB_{—} Database access functions |
| #include “Stack.h” | // S_{—} Stack for floor prices |
| #include “Notify.h” | // N_{—} Draft notifications and hand them to sendmail |
| struct BidData { | // Attach some extra fields to each stacked floor bid |

| | |
|---|---|
| int | numunits; |
| P_Index | bidID; |

BidData (int n, P_Index i) {numunits = n; bidID = i;}; // Constructor
};
// Global variables visible to both AddpointTocurve( ) and main( )
//

| | | |
|---|---|---|
| DB_YieldAuctionQuery* | auction; | |
| DB_YieldCurveUpdate* | yieldCurve; | |
| DB_yieldAuctionUpdate* | auctionUpdate; | |
| P_Pennies | floorYield; | // Accumulate floor amounts |
| int | count; | // Count *all* bids’ number of units resting on testprice |

| | |
|---|---|
| void AddPointToCurve ( ) { | // steps to be performed in two places |

yieldCurve->yield = floorYield + (count*(yieldCurve->price − auction->estUnitCost));

| | |
|---|---|
| yieldCurve->save ( ); | // Save each point in yield curve |

```
    if (yieldCurve->yield > auctionUpdate->maxYield) {
        auctionUpdate->maxYield = yieldCurve->yield;
        auctionUpdate->bestPrice = yieldCurve->price;
    }
}
// Main Program
//
int main (int argc, char **argv) {
```

| | | |
|---|---|---|
| DB_YieldBundleUpdate* | bundleUpdate; | // Save (re)calculated bundle values |
| N_PriceChange* | priceChange; | // Event handler for bids moving into or out of the money |
| N_Vaporware* | vaporware; | // Event handler for auctions that yield 100% before deliverable |
| N_PhaseChange* | phaseChange; | // Event handler for auction phase changes |
| DB_YieldBidQuery* | bid; | // To figure yield, get all bids for one auction |
| DB_YieldBidUpdate* | bidupdate; | // Save daily status of each bid |
| P_Index | bundleID; | // Lead auction (productID) identifying bundle |
| S_IntStack | productStack; | // Save all productIDs in each bundle in case phase changes |
| S_IntStack | vaporstack; | // Save non-authenticated productIDs in case yield exceeds 100% |
| P_AuctionPhase | phase; | // Bundle phase |
| P_Pennies | targetYield; | // Don't use seller's reserve -- it doesn't include our fee! |
| time_t | targetDate; | // Bundle's earliest possible release date |
| time_t | ripeDate; | // Bundle's first-time-ripe timestamp |
| P_Pennies | bundleYield; | // Sum maxYields of all auctions in each bundle |
| S_ComplexStack | floorStack; | // Buffer and sort non-trivial bid floors until needed |
| P_Pennies | floor; | // Examine one bid floor |
| BidData* | bidData; | // Data to save with each floor |
| int | moreAuctions; | // Flag for awkward final bundle loop termination |

| | | |
|---|---|---|
| DB_Hoststring | = argv[1]; | // Publish database parameters |

| | |
|---|---|
| auction | = new DB_YieldAuctionQuery ( ); |

| | |
|---|---|
| auction->GetAll ( ); | // Fetch all open auctions sorted by bundle; load first |
| if (!auction->Count ( )) { | // No auctions! Not much to do today |

fprintf (stderr, “No volatile auctions found by YieldCalc today, %s”, ctime (&P_EXEC_TIME));

| | |
|---|---|
| return 1; | // Quit program with error status |

| | | |
|---|---|---|
| } | | // Having auctions, construct data structures |
| yieldCurve | = new DB_YieldCurveUpdate ( ); | // One yield curve update object for all yield curves |
| auctionupdate | = new DB_YieldAuctionUpdate ( ); | // one status update object for all auctions |
| bundleupdate | = new DB_YieldBundleUpdate ( ); | // one bundle update object to save any auction bundle |
| pricechange | = new N_PriceChange ( ); | // Create synchronous notification composer/spooler |
| vaporware | = new N_Vaporware ( ); | // ” |
| phasechange | = new N_PhaseChange ( ); | // ” |
| bid | = new DB_YieldBidQuery ( ); | // Gets bids for one auction at a time |
| bidupdate | = new DB_YieldBidUpdate ( ); | // Save bid status, rank and amount bidder would pay |
| do { | // Loop over auction *bundles* | |

| | |
|---|---|
| bundleID = auction->withproductID; | // Establish bundle identifier (first auction in set) |
| phase = auction->phase; | // Remember data shared by all auctions in bundle |
| targetYield = auction->targetYield; | // ” ; These values would otherwise be unavailable by |
| targetDate = auction->targetDate; | // ” ; the time we discover that we've looped to an |
| ripeDate = auction->ripeDate; | // ” ; auction in the next bundle |
| bundleYield = 0; | // P_Pennies variables |
| bundleUpdate->Start (bundleID); | // Initialize bundle record update |
| do { | |
| productStack.Push (auction->productID); | // Add an auction to bundle |
| if (!auction->authentic) { | |
| vaporStack.Push (auction->productID); | // ...not so judged unless auction targets met |
| } | |
| auctionUpdate->Start (auction->productID); | // Initialize auction status record update |
| yieldCurve->Start (auction->productID); | // ditto yield curve, plus erase yesterday's |
| bid->Get (auction->productID); | // Fetch & sort (unexpired) bids; load first |
| if (!bid->Count ( )) { | // If no bids in this auction |
| auctionUpdate->Save ( ); | // Store trivial auction status |
| continue; | // skip to loop bottom (next auction) |
| } | // Re-initialize the following for each auction... |
| yieldCurve->price = bid->ceiling; | // Start test price at highest bid |
| yieldCurve->yield = floorYield = 0; | // Reset monetary zeroes |
| count = 0; | // Reset integer zero |
| do { | // For each bid in auction... |
| if (bid->ceiling < yieldCurve->price) { | // If ceiling is different |
| AddPointToCurve ( ); | // Calculate yield at *prior* (completed) test price |

| | |
|---|---|
| yieldCurve->price = bid->ceiling; | // And move test price to new ceiling, which means that |

| | |
|---|---|
| while (floorStack.More ( )) { | // Some bids might now rest on their floors... |

| | |
|---|---|
| if (!floorYield) floorStack.Rewind ( ); | // Must seek head until we've already used at least one |

| | |
|---|---|
| floor = floorStack.CurInt ( ); | // Examine highest unused floor in Stack |
| if (floor > yieldCurve->price) { | // If higher than (not equal to) new test price then |

bidData = (BidData*) floorStack.CurData ( ); // Retrieve (pointer to) attached data

// Accumulate floored bids' gross profits

floorYield += (bidData->numUnits) * (floor − auction->estUnitCost);

| | |
|---|---|
| count −= bidData->numUnits; | // Remove bid's numUnits from test price's multiplier |
| floorStack.Next ( ); | // Non-destructively walk to next floor |
| } else { | |

| | |
|---|---|
| break; | // Having hit unneeded floor, leave remainder for later |
| } | |

| | |
|---|---|
| } | // Count will decrement when floors used, but |
| } | // it won't reset until next *auction*. |
| count += bid->numUnits; | // Add bid's unit count at test price |
| floor = bid->floor; | // Because a bid's floor <= ceiling, |
| | // floors always stacked before needed |
| if (floor > P_MinimumBid ( )) { | // Only stack non-trivial floors |

bidData = new BidData (bid->numUnits, bid->bidID); // Allocate and load

| | |
|---|---|
| floorStack.Push (floor, bidData); | // Sort floor into Stack with its (pointer to) data |
| } | // Push adjusts current stack position if necessary |
| } while (bid->FetchNext( )); | // Return false (ending loop) when dry |
| AddPointToCurve ( ); | // Process the last test price at lowest ceiling |

if (auctionUpdate->bestPrice != auction->bestPrice) { // If best price changed, update and notify

| | |
|---|---|
| bidUpdate->Start (auction->productID); | // Initialize for many status updates for this auction |
| bidUpdate->rank = 2; | // Overrule default; #1 is reserved for seller |
| bidUpdate->status = PREMIUM; | // Start with bids having floors > bestPrice |
| if (floorStack.Any ( )) { | // This being last pass, we can revert to top & pop |

```
                while (floorStack.TopInt ( ) > auctionUpdate->bestPrice) {  // but only above *best* price
                    bidUpdate->due = bidData->numUnits * floorStack.TopInt ( );
                    bidData = (BidData*) floorStack.TopData ( ); // Retrieve attached data
```

| | |
|---|---|
| bidUpdate->bidID = bidData->bidID; | // Set the real update index |
| bidUpdate->Save ( ); | |
| bidUpdate->rank += bidData->numUnits; | // Increment is probably one |
| floorStack.Pop ( ); | // UnStack and |
| delete bidData; | // Clean up attached memory |
| } | |
| floorStack.Clear ( ); | // Discard unused floors (if any) and delete data |
| } | |
| bidUpdate->status = IN; | // Continue with bids in the money |
| bid->Rewind ( ); | |
| do { | |

```
                if (bid->ceiling < auctionUpdate->bestPrice) break;
                if (bid->floor < auctionUpdate->bestPrice) {// If not handled while unwinding floorStack
                    bidUpdate->due = bid->numUnits * auctionUpdate->bestPrice;
                    bidUpdate->bidID = bid->bidID;
                    bidUpdate->Save ( );
```

| | |
|---|---|
| bidUpdate->rank += bid->numUnits; | // Increment rank by number of units in bid |
| } | |
| } while (bid->FetchNext( )); | |
| bidUpdate->status = OUT; | // Continue with bids out of the money |

| | |
|---|---|
| bidUpdate->due = 0; | // off the hook until/unless price falls (which it can) |

| | |
|---|---|
| if (bid->More ( )) do { | // Concatenated if ... loop |
| bidUpdate->bidID = bid->bidID; | |
| bidUpdate->Save ( ); | |
| bidUpdate->rank += bid->numUnits; | // Increment rank by number of units in bid |
| } while (bid->FetchNext( )); | |

```
                pricechange->Notify (auction->productID, auction->bestPrice, auctionUpdate->bestPrice);
            } // Notify will filter recipient list by user prefs
            // Here we could search yieldCurve for a secondary relative maximum (“second-best” price and its yield)
            bundleYield += auctionUpdate->maxYield;
```

| | |
|---|---|
| auctionUpdate->Save ( ); | // Save calculations to DB |
| moreAuctions = auction->FetchNext( ); | // Load next auction |

```
        } while (moreAuctions && (auction->withProductID == bundleID)); // compare bundleID
        bundleUpdate->yieldPct = (100*bundleYield)/targetYield;
```

| | |
|---|---|
| bundleUpdate->phase = phase; | // Presume no change |
| if (phase == NEW) { | // Then start testing |

if (bundleUpdate->yieldPct >= P_SIGNIFICANT_YIELD_RATIO) {

| | |
|---|---|
| bundleUpdate->phase = DEVELOPMENT; | // Allow best price and yield-pct to be displayed |
| } | |
| } else if (vaporStack.Any ( )) { | // Sidestep all other phase tests |
| bundleUpdate->phase = DEVELOPMENT; | // Possibly reverting from more advanced phase |
| if (bundleUpdate->yieldPct >= 100) { | // Hope this happens, but only in unsolicited auctions |

```
                vaporware->Notify (bundleUpdate->index, &vaporStack);  // Alert the admin and possible seller
            }
        } else if (phase == DEVELOPMENT) {
            bundleUpdate->phase = DELIVERABLE;
        } else if ((P_WAKE_TIME >= targetDate) && (bundleUpdate->yieldPct >= 100)) {
```

| | |
|---|---|
| bundleUpdate->phase = RIPE; | // Hit both targets, trigger fund verification/capture |
| if (!ripeDate) { | // If this bundle hasn't been here before, |
| bundleUpdate->phaseStamp = P_WAKE_TIME; | // Remember this day |
| } | |
| } else if (phase == RIPE) { | // Failed target(s) during funding; payments canceled? |
| bundleUpdate->phase = DELIVERABLE; | // Revert, postponing further fund verification |
| } | |
| bundleUpdate->Save ( ); | |
| while (productStack.Any ( )) { | |
| if (bundleUpdate->phase != phase) { | // If phase changed, then notify product's bidders |

```
                phaseChange->Notify (productStack.TopInt ( ), phase, bundleUpdate->phase);
            }
```

| | |
|---|---|
| productStack.Pop ( ); | // Changed or not, empty the Stack |
| } | |
| vaporStack.Clear ( ); | // In case it went unused |
| } while (moreAuctions); | // “moreAuctions” was set at end of auction loop |
| delete bid; | // Clean up RAM |
| delete priceChange; | // (Stacks clean up after themselves) |
| delete vaporware; | |
| delete phaseChange; | |
| delete bundleUpdate; | |
| delete auctionUpdate; | |
| delete yieldCurve; | |
| delete auction; | |
| return 0; | // apparent success |
| } | |
| // END YieldCalc.cpp | |

The payment processing processes 544 may provide such functionalities as verifying bidder funds, securing funds associated with winning bids, and the like, and may include any of the functionalities relating to payment processing described above. The functionalities of the payment processing processes 544 may be implemented as part of the web site 500, or as third party payment processing systems in communication with the web site 500.

The fulfillment processes 546 may provide for the generation of seed versions of the creative work, the packaging and distribution of the seed versions to successful bidders, and the like, and may include any of the functionalities relating to fulfillment and distribution described above. The functionalities of the fulfillment processes 546 may be implemented as part of the web site 500, or as third party fulfillment systems in communication with the web site 500.

The notifications processes 550 may include one or more processes that notify users of particular events. For example, a notification may be sent to a seller as the auction progresses from phase to phase, as described above, or when the target yield for an auction has been satisfied, and the like. Bidders may receive notifications when information associated with a work for which they have bid is changed, when they have been outbid, when their bid expires, when insufficient funds are maintained in their account for a particular bid placed, and the like. Other notifications may also be sent to users, including both buyers and sellers. For example, notifications may also be sent to users whenever registration data is changed. It should be apparent to one of ordinary skill in the art that any event in the lifecycle of an auction may trigger a notification. The notification may be implemented as an email, instant message, or other means of communication with a user, or as a page of the web site 500. Finally, the data warehousing processes 552 may include one or more processes related to data warehousing functionalities.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A method of auctioning a creative work, the method comprising:
initiating an auction for the creative work, where one or more successful bidders receive at least one copy of the creative work;
receiving bids for the creative work from potential buyers;
closing the auction;
determining the successful bidders;
generating a limited number of copies of the creative work, the limited number based in part on the determined successful bidders, where each of the limited number of copies is associated with a unique identifier;
awarding each successful bidder at least one of the limited number of copies.

2. The method of claim 1 further comprising releasing at least one right associated with the creative work into the public domain.

3. The method of claim 1, where the unique identifiers are monotonically increasing numbers.

4. The method of claim 3, where the creative work is associated with a seller, the method further comprising:
causing the seed version associated with the lowest unique identifier to be distributed to the seller.

5. The method of claim 4, further comprising:
causing the seed versions to be distributed to the buyers in accordance with the unique identifiers.

6. The method of claim 1, where each bid includes a minimum value and a maximum value.

7. The method of claim 6, where the unique identifiers are associated with the bids in accordance with the maximum values of the bids.

8. The method of claim 6, where the unique identifiers are associated with the bids in accordance with the minimum values of the bids.

9. The method of claim 6, where each bid is associated with a bid time reflecting when the associated bid is placed or last increased.

10. The method of claim 9, where the unique identifiers are associated with the bids in accordance with the bid times.

11. The method of claim 1, where the auction is a buyer-initiated auction.

12. The method of claim 1, further comprising:
initiating a second auction for a second creative work,
receiving bids for the second creative work from potential buyers;
closing the auction and the second auction when a combined profit from both auctions exceeds a predetermined threshold.

13. A system for distributing intellectual property works, the system comprising:
a creative work definition component, the creative work definition component operable to input an identifying description of a creative work into the system;
a work offering component operable to offer, via an auction, the creative work associated with a seller, the creative work associated with a reserve yield value;
a bid reception component in communication with the creative work offering component and operable to receive bids for the creative work from potential buyers, each bid including a maximum value;
a bid tabulation component in communication with the bid reception component and operable to calculate a yield value for a plurality of potential unit prices, the bid tabulation component further operable to determine a final unit price for the creative work based on the calculated yield values;
a winning bid selection component in communication with the bid reception component and bid tabulation component, the winning bid selection component operable to select those bids having a maximum value equal to or greater than the final unit price;
a collection component in communication with the bid reception component and the bid tabulation component, the collection component operable to cause funds to be secured from the buyers for the selected bids; and
a work generation component in communication with the collection component, the work generation component operable to cause a copy of the creative work to be generated for each bid for which funds are secured, where the works are serially labeled.

14. The system of claim 13, further comprising:
a creative work wanted component, in communication with the creative work definition component, operable to solicit, via an auction, a creative work not yet associated with a willing seller, so that speculative buyers may attempt to accumulate a potential yield.

15. A method of auctioning a creative work, the method comprising:
initiating an auction for the creative work;
receiving bids from potential buyers, each bid including a maximum value;
determining a final unit price for the creative work, where at least one bid includes a premium indicative of an amount above the final unit price;
selecting a subset of winning bids from the received bids in accordance with the final unit price;
generating at least one copy of the creative work for each winning bid; and
awarding the copies to the buyers placing the winning bids in accordance with the premium.

16. The method of claim 15, where the generated copies are associated with a unique identifier.

17. The method of claim 15, further comprising:
ranking the winning bids; and
awarding the generated copies in accordance with the ranking.

18. The method of claim 17, further comprising automatically generating publicity for the winning bidders in accordance with the ranking.

19. The method of claim 15, where the work is associated with a seller and the generated copies are associated with an ordinal ranking, the method further comprising awarding the generated copy with the lowest ordinal ranking to the seller.

20. The method of claim 15, where at least one bid includes a minimum value, the method further comprising determining the premium in accordance with the minimum bid value.

21. The method of claim 15, where the unit price is a profit maximizing unit price.

22. The method of claim 15, further comprising awarding, to the buyers placing the winning bids, at least one right selected from the group comprising a right to copy the work, a right to compress the work, a right to redistribute the work, and/or a right to transmit the contents of the generated copy.

23. A method of auctioning a creative work, the method comprising:
receiving a request for initiating of an auction for the creative work from a potential buyer,
initiating the auction;
receiving bids for the creative work from potential buyers;
receiving, after receiving at least one bid, finalized auction terms from an owner of the work,
closing the auction; and
determining the successful bidders.
